(19) United States
(12) Patent Application Publication
(10) Pub. No.: US 2017/0044709 A1
(43) Pub. Date: Feb. 16, 2017

(54) METHODS FOR TREATING REINFORCING FIBER AND TREATED REINFORCING FIBERS

(71) Applicant: 3M INNOVATIVE PROPERTIES COMPANY, St. Paul, MN (US)

(72) Inventors: Zeba Parkar, Woodbury, MN (US); Seth M. Kirk, Minneapolis, MN (US); Moses M. David, Woodbury, MN (US); Craig A. Miller, Lake Elmo, MN (US); Derrick M. Poirier, Eden Prairie, MN (US)

(21) Appl. No.: 15/304,096

(22) PCT Filed: Apr. 30, 2015
(86) PCT No.: PCT/US2015/028427

§ 371 Date: Oct. 14, 2016

Related U.S. Application Data
(60) Provisional application No. 61/986,414, filed on Apr. 30, 2014.
(60) Provisional application No. 62/153,281, filed on Apr. 27, 2015.

(51) Int. Cl. D06M 10/02; C08J 5/08; C08J 5/06; C03C 25/62; C08J 5/24

(52) U.S. Cl. CPC D06M 10/025; C03C 25/6293; C08J 5/24; C08J 5/06; C08J 5/08; D06M 2400/01; C08J 2363/00; D06M 2200/40; D06M 2101/40

(57) ABSTRACT

Surface treated fibers and methods of treating individual fiber surfaces. One exemplary method includes subjecting a precursor gas to a plasma-generating discharge within an atmospheric plasma generator to generate a reactive species flow including reactive oxygen species, and exposing a reinforcing fiber to the reactive species flow for a treatment time sufficient to functionalize the reinforcing fiber with oxygen such that at least one of a composite matrix interfacial adhesion of the reinforcing fiber or a composite matrix interfacial strength of the reinforcing fiber, increases. The precursor gas preferably includes a carrier gas and an oxidative gas, the oxidative gas being contained in an amount of up to 25% by volume of the precursor gas.

### FIELD

The present application provides methods for treating reinforcing fibers and treated reinforcing fibers.

### BACKGROUND

Fibers such as carbon fibers, ceramic fibers and glass fibers are used as reinforcing fibers in polymer matrices to form structural composites. Such fiber-reinforced structural composites must meet a number of performance requirements for each particular application. One important performance requirement for fiber-reinforced polymer composites used, for example, in aerospace pre-pregs or to manufacture lightweight composite pressure vessels, is the strength of the cured fiber-reinforced structural composite. There is a continuing need to improve the strength of fiber-reinforced structural composites for such high strength applications.

### SUMMARY

Atmospheric plasma treatment of reinforcing fibers using oxidative gases was surprisingly found to improve the properties, particularly the strength, of fiber-reinforced polymer composites made using the treated reinforcing fibers, even when relatively low concentrations of oxidative gases were used.

Thus, in one aspect, the present disclosure describes a method for treating reinforcing fibers (Embodiment A) including transporting a precursor gas including a carrier gas and an oxidative gas having up to 25% by volume of the precursor gas to an atmospheric plasma-generating discharge within an atmospheric plasma generator to generate a reactive species flow, and exposing an untreated reinforcing fiber to the reactive species flow for a treatment time sufficient to functionalize the reinforcing fiber with oxygen such that at least one of a composite matrix interfacial adhesion of the treated reinforcing fiber or a composite matrix interfacial strength of the treated reinforcing fiber, increases. The reactive species flow includes reactive oxygenated species produced from the oxidative gas.

### LISTING OF EXEMPLARY EMBODIMENTS

B. The method of Embodiment A, wherein the untreated fiber has a sizing material on at least a portion of an exterior surface of the untreated fiber, and further wherein the treated fiber is substantially free of the sizing material.
C. The method of any preceding Embodiment, wherein exposing the untreated reinforcing fiber to the reactive species flow further includes maintaining the reinforcing fiber at a distance from the atmospheric plasma-generating discharge so that the reinforcing fiber is not damaged by the atmospheric plasma-generating discharge.
D. The method of any preceding Embodiment, wherein the oxidative gas includes O₂, air, N₂O, NO₂, or a combination thereof
E. The method of any preceding Embodiment, wherein the carrier gas includes helium, argon, or a combination thereof
F. The method of any preceding Embodiment, wherein the atmospheric plasma-generating discharge is selected from an electric discharge, a spark discharge, a gliding arc discharge, a corona discharge, a pulsed corona discharge, a radio frequency plasma discharge, a microwave frequency discharge, a glow discharge, a diffuse barrier discharge, an atmospheric pressure jet discharge, or a combination thereof.
G. The method of any preceding Embodiment, wherein the treatment time is selected from 0.01 seconds to 10 minutes.
H. The method of any preceding Embodiment, further comprising shielding from a surrounding atmosphere a plasma treatment zone through which the reactive species flow and the reinforcing fiber are passed.
I. The method of Embodiment H, wherein the shielding includes enclosing the plasma treatment zone.
J. The method of Embodiment H or I, wherein the plasma treatment zone is maintained at a pressure from 1×10⁻⁶ atmosphere to 10 atmospheres.
K. The method of any one of Embodiment H, I, or J, further including purging the plasma treatment zone with a purge gas, wherein the purging occurs before the exposing step, during the exposing step, after the exposing step, or a combination thereof.
L. The method of any preceding Embodiment, further comprising transporting the reactive gas flow from the atmospheric plasma generator to the untreated reinforcing fiber, optionally wherein the transporting includes directing the reactive species flow towards an exterior surface of the untreated reinforcing fiber.
M. The method of embodiment L, wherein the transporting further includes shielding the reactive species flow from a surrounding atmosphere.
N. The method of any preceding Embodiment, wherein a surface oxygen concentration of the treated reinforcing fiber measured using X-ray Photoelectron Spectroscopy (XPS) increases by at least 10% relative to a surface oxygen concentration of the untreated reinforcing fiber measured using XPS.
O. The method of any preceding Embodiment, wherein the untreated reinforcing fiber is selected from a carbon fiber, a ceramic fiber, a glass fiber, a (co)polymeric fiber, or a natural fiber.
P. The method of Embodiment O, wherein the untreated reinforcing fiber is free of a sizing material.

In another aspect, the present disclosure describes a method of fabricating a fiber-reinforced composite using any of the foregoing process embodiments for treating reinforcing fibers. In some exemplary embodiments, the fiber-reinforced composite includes a multiplicity of treated reinforcing fibers selected from carbon fibers, ceramic fibers, glass fibers, (co)polymeric fibers, natural fibers, or a combination thereof. In certain exemplary embodiments, the multiplicity of treated reinforcing fibers includes a fiber tow.

In a further aspect, the present disclosure describes a fiber-reinforced composite including the treated reinforcing fiber produced according to any of the preceding embodiments. The fiber-reinforced composite may be selected from an uncured fiber-reinforced pre-preg composite, a partially-cured fiber-reinforced composite, or a fully-cured fiber-reinforced composite.

Various aspects and advantages of exemplary embodiments of the disclosure have been summarized. The above Summary is not intended to describe each illustrated embodiment or every implementation of the present certain exemplary embodiments of the present disclosure. The Drawings and the Detailed Description that follow more particularly exemplify certain preferred embodiments using the principles disclosed herein.

### BRIEF DESCRIPTION OF THE DRAWINGS

The disclosure may be more completely understood in consideration of the following detailed description of various embodiments of the disclosure in connection with the accompanying figures, in which:

FIG. 1A is a schematic view of an exemplary apparatus for treating a reinforcing fiber.

FIG. 1B is a schematic view of an exemplary plasma treatment zone shielded from the surrounding atmosphere by a curtain of shield gases.

FIG. 1C is a schematic view of an exemplary plasma treatment zone shielded from the surrounding atmosphere by an enclosure.

FIG. 1D is a schematic view of an exemplary plasma treatment zone purged with a purge gas.

In the drawings, like reference numerals indicate like elements. While the above-identified drawing, which may not be drawn to scale, sets forth various embodiments of the present disclosure, other embodiments are also contemplated, as noted in the Detailed Description. In all cases, this disclosure describes the presently disclosed disclosure by way of representation of exemplary embodiments and not by express limitations. It should be understood that numerous other modifications and embodiments can be devised by those skilled in the art, which fall within the scope and spirit of this disclosure.

### DETAILED DESCRIPTION

The performance of fiber-reinforced composite materials, such as carbon fiber reinforced (co)polymer matrix composites, depends not only on the properties of the fiber and the surrounding matrix, but also on the interface between the individual exterior fiber surfaces and the matrix material. This interface can play an important role in determining the failure mechanism, fracture toughness and the overall stress-strain behavior of the composite material. A strong interfacial bond results in efficient stress transfer between the fiber and the matrix in turn leading to stronger composite parts.

We have surprisingly found that atmospheric plasma treatment of reinforcing fibers using oxidative gases can significantly improve the strength of fiber-reinforced polymer composites made using the treated reinforcing fibers, even when relatively low concentrations of oxidative gases are used in the treatment process to prevent damage to the treated fibers.

Thus, in one aspect, the present disclosure describes a method for treating reinforcing fibers including transporting a precursor gas including a carrier gas and an oxidative gas having up to 25% by volume of the precursor gas to an atmospheric plasma-generating discharge within an atmospheric plasma generator to generate a reactive species flow, and exposing an untreated reinforcing fiber to the reactive species flow for a treatment time sufficient to functionalize the reinforcing fiber with oxygen such that at least one of a composite matrix interfacial adhesion of the treated reinforcing fiber or a composite matrix interfacial strength of the treated reinforcing fiber, increases. The reactive species flow includes reactive oxygenated species produced from the oxidative gas. In some exemplary embodiments, a surface oxygen concentration of the treated reinforcing fiber measured using X-ray Photoelectron Spectroscopy (XPS) increases by at least 10% relative to a surface oxygen concentration of the untreated reinforcing fiber measured using XPS.

Furthermore, there are a number of processes that require removal of sizing (e.g., protective coatings for carbon fibers, silanes for ceramic or glass fibers) before coating with the (co)polymer resin used in forming the composite. Sizing helps in improving the abrasion resistance of the fiber as well as bending strength. However, sporadically, the sizing functional groups can be preferentially adsorbed on the fiber surface and can obstruct its dissolution in the polymer matrix during composites manufacturing and can results in weak fiber/matrix interface.

Conventionally in fiber-reinforced composite processing, high temperature ovens/furnaces are used to remove these organic molecules. These ovens are highly energy inefficient, high temperatures, long-residence times are required for complete removal of sizing. Moreover, the oxidizing chemistry involved and long-residence times can lead to oxidation of the fiber surface and possibly reduce the strength of the fiber by introducing surface defects. Therefore, fibers often need de-sizing (removal of surface coatings) before they can be processed further. However, de-sizing increases costs and overall process times, and can even impact fiber quality if harsh treatments are involved.

In further exemplary embodiments, we have discovered that a radio-frequency (RF) capacitive discharge plasma generate remote from the fiber itself may be used to efficiently remove unwanted sizing materials from the fiber surface without damaging the fiber or otherwise degrading the fiber tensile strength. The efficiency of sizing removal from the substrate can be varied by varying the amount of O₂ passing through the electrodes of the plasma generator and the distance from the treatment head.

Thus, in further exemplary embodiments, the present disclosure provides a process that rapidly and efficiently removes sizing materials from the surface of various kinds of fibers, including carbon, ceramic, and glass fibers, without impacting critical fiber properties such as tensile strength. The process uses low-oxygen remote atmospheric plasma that effectively reduces and eliminates unwanted surface coatings while avoiding fiber degradation associated with high-oxygen plasmas or degradation associated with contact between the plasma discharge source and the fiber.

Unlike conventional corona treatments, the discharge is very uniform with minimal arcing. Therefore, damage to fiber resulting from stray or filamentary discharge is eliminated. Additional heating in the form of IR lamps before exposing the fibers to plasma discharge can increase in efficiency and reduce the residence time required in the plasma. Unlike other known plasma processes, the present process avoids the use of high concentrations of oxygen species in the plasma stream, minimizing oxidative damage to the fiber.

The following Glossary of defined terms provides definitions that are intended to be applied for the entire application, unless a different definition is provided in a particular context in the claims or elsewhere in the specification.

### GLOSSARY

Certain terms are used throughout the description and the claims that, while for the most part are well known, may require some explanation. It should understood that:

“Plasma” means an at least partially ionized gaseous or fluid state of matter containing reactive species that include electrons, ions, neutral molecules, free radicals, and other excited state atoms and molecules. Visible light and other radiation are typically emitted from the plasma as the species included in the plasma relax from various excited states to lower or ground states.

“Atmospheric plasma” is plasma generated at pressures higher than vacuum, including sub-atmospheric pressure, atmospheric pressure, and super-atmospheric pressures. Atmosphere may refer to either the pressure of the atmosphere, or may generally denote the pressure of the environment surrounding the plasma apparatus. Atmospheric pressure may fluctuate with temperature and composition of the gaseous and other components of the environment immediately surrounding the plasma apparatus.

The terms “(co)polymer” or “(co)polymers” include homopolymers and copolymers, as well as homopolymers or copolymers that may be formed in a miscible blend, e.g., by coextrusion or by reaction, including, e.g., transesterification. The term “copolymer” includes random, block and star (e.g. dendritic) copolymers.

As used herein, variations of the words “comprise”, “comprising,” “include,” “including,” “has,” and “have” are legally equivalent and open-ended. Therefore, additional non-recited elements, functions, steps or limitations may be present in addition to the recited elements, functions, steps, or limitations.

As used in this specification and the appended embodiments, the singular forms “a”, “an”, and “the” include plural referents unless the content clearly dictates otherwise. Thus, for example, reference to fine fibers containing “a compound” includes a mixture of two or more compounds. As used in this specification and the appended embodiments, the term “or” is generally employed in its sense including “and/or” unless the content clearly dictates otherwise.

As used in this specification, the recitation of numerical ranges by endpoints includes all numbers subsumed within that range (e.g. 1 to 5 includes 1, 1.5, 2, 2.75, 3, 3.8, 4, and 5). At the very least, and not as an attempt to limit the application of the doctrine of equivalents to the scope of the claimed embodiments, each numerical parameter should at least be construed in light of the number of reported significant digits and by applying ordinary rounding techniques.

Unless otherwise indicated, all numbers expressing quantities or ingredients, measurement of properties and so forth used in the specification and embodiments are to be understood as optionally being modified in all instances by the term “about.” Thus, all numbers used herein are to be understood to include the exact number, as well as the number as modified by the term “about.”

Furthermore, the terms “about” or “approximately” with reference to a numerical value or a shape means+/−five percent of the numerical value or property or characteristic, but expressly includes the exact numerical value. For example, a pressure of “about 1 atmosphere” is intended to cover pressures from 0.95 atmosphere to 1.05 atmospheres, inclusive, but also expressly includes a pressure of 1.00 atmosphere.

The term “substantially” with reference to a property or characteristic means that the property or characteristic is exhibited to within 95% of that property or characteristic. Thus, a fiber that is described as “substantially free of sizing material” is intended to describe a fiber that is 95% or more free of sizing, but also expressly includes a fiber completely (100%) free of sizing material.

Various exemplary embodiments of the disclosure will now be described with particular reference to the Drawings. Exemplary embodiments of the present disclosure may take on various modifications and alterations without departing from the spirit and scope of the disclosure. Accordingly, it is to be understood that the embodiments of the present disclosure are not to be limited to the following described exemplary embodiments, but are to be controlled by the limitations set forth in the claims and any equivalents thereof.

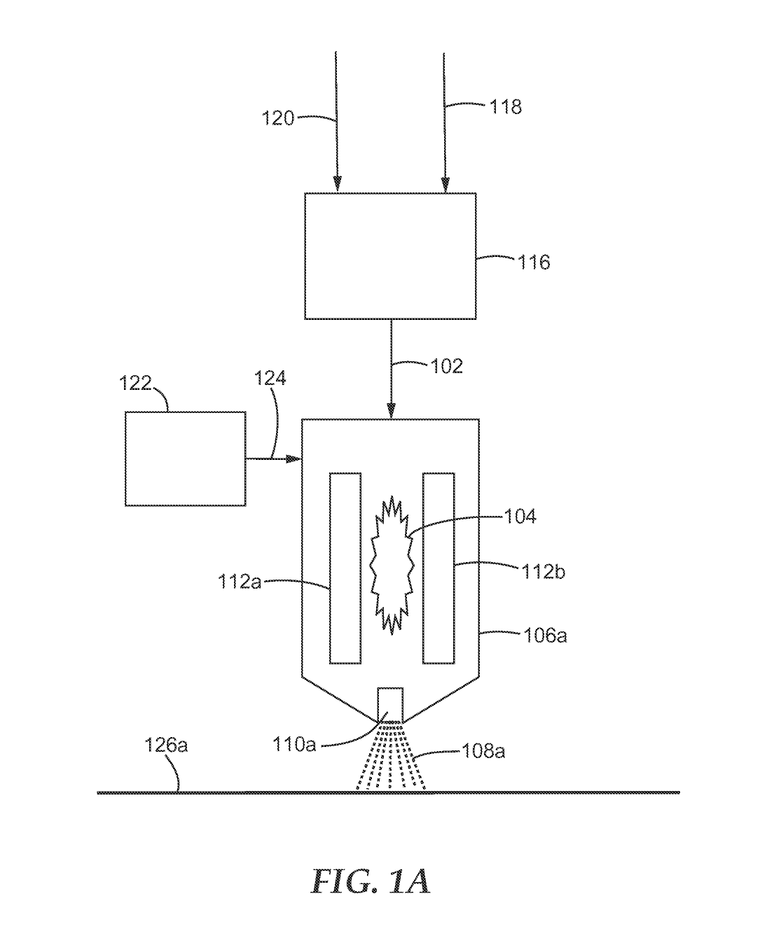

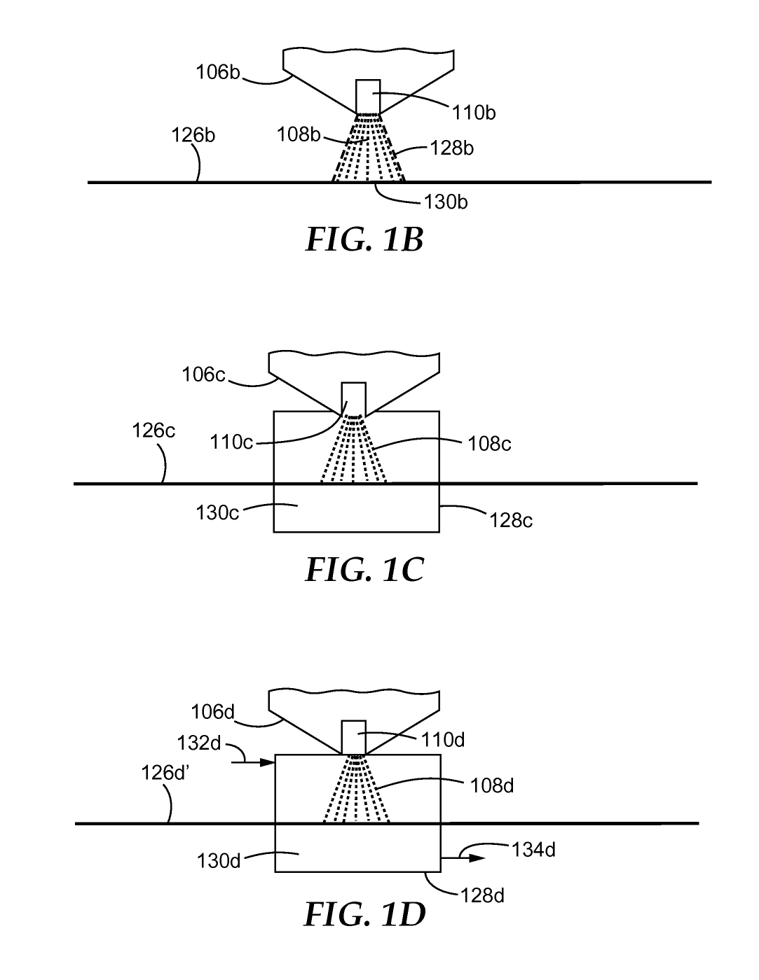

Referring now to FIG. 1A, Precursor gas 102 is fed to an atmospheric plasma generator 106. The precursor gas 102 is subjected to a plasma-generating discharge 104 within the atmospheric plasma generator 106, whereby a reactive species flow 108 is generated by the atmospheric plasma generator 106, exiting through an aperture 110. A reinforcing fiber 126 is exposed to the reactive species flow 108 for a treatment time. The reactive species flow 108 includes reactive oxygen species that functionalize the surface of the reinforcing fiber 126, thereby increasing at least one of a composite matrix interfacial adhesion or a composite matrix interfacial strength of the reinforcing fiber 126.

The precursor gas 102 is generated by a gas controller 116. The gas controller 116 can be used to feed precursor gas 102 of a predetermined gas composition or a predetermined gas mixture into the atmospheric plasma generator 106 (in this context, the term gas is used to broadly encompass any material that can be volatilized to a sufficient extent to be provided in a reaction chamber of a plasma reactor). Oxidative gas 120 and carrier gas 118 are fed to the gas controller 116. The gas controller 116 regulates the flow and pressure of each of the oxidative gas 120 and carrier gas 118, mixes or otherwise combines the oxidative gas 120 and the carrier gas 118 to produce the precursor gas 102, and regulates the flow and pressure of the precursor gas 102 fed to the atmospheric plasma generator 106.

In various embodiments, the precursor gas 102 is generated by mixing or otherwise combining carrier gas 118 and oxidative gas 120. In various embodiments, the carrier gas 118 includes one or more gases that are susceptible to plasma breakdown to form plasma when subjected to the plasma-generating discharge 104. In an embodiment, the carrier gas 118 includes an inert gas such as argon, helium, xenon, radon, or any mixture thereof that are susceptible to plasma breakdown. In an embodiment, the carrier gas 118 contains 100% by volume of argon. In another embodiment, the carrier gas 118 includes less than 100% by volume, but more than 0.01% by volume, of argon. In an embodiment, the carrier gas 118 contains 100% by volume of helium. In another embodiment, the carrier gas 118 includes less than 100% by volume, but more than 0.01% by volume, of helium.

In various embodiments, the oxidative gas 120 includes an oxidizing gas such as an oxygen-containing gas such as oxygen, air, carbon dioxide, N₂O, NO₂, H₂O, H₂O₂, O₃ or any other oxidizing gases or combinations thereof. Without being bound by theory, the concentration of oxidative gas 120 in the precursor gas 102 should be sufficient to generate a sufficient concentration of reactive oxygen species in the reactive species flow 108 to effectively functionalize the reinforcing fiber 126 with oxygen. However, without being bound by theory, it is thought that a high concentration of the oxidative gas 120 or the oxidizing gases may promote filamentary discharge or other unwanted stray discharges that may potentially damage the reinforcing fiber 126. In various embodiments, the precursor gas 102 includes at least 0.01% by volume, and at most 25% by volume, of the oxidative gas 120. In an embodiment, the precursor gas 102 includes at least 0.1% by volume, and at most 10% by volume, of the oxidative gas 120. In another embodiment, the precursor gas 102 includes at least 0.5% by volume, and at most 3% by volume, of the oxidative gas 120.

In an embodiment, the oxidative gas 120 contains 100% by volume of oxygen. In another embodiment, the oxidative gas 120 includes less than 100% by volume, but more than 0.01% by volume, of oxygen. In yet another embodiment, the oxidative gas 120 includes more than 0.01% by volume of air and up to 100% by volume of air. In various embodiments, the precursor gas 102 includes at least 0.01% by volume, and at most 25% by volume, of the oxidizing gases in the oxidative gas 120.

The atmospheric plasma generator 106 may assume any suitable shape, geometry or configuration such as a box, a cube, a cylinder, or any other chosen shape. In an embodiment, the atmospheric plasma generator 106 is stationary. In another embodiment, the atmospheric plasma generator 106 can be moved. In yet another embodiment, the atmospheric plasma generator 106 is a hand-held device.

The pressure within the atmospheric plasma generator 106 may be maintained at any pressure that is conducive to the formation of suitable plasma. In certain presently preferred embodiments, the pressure within the atmospheric plasma generator 106 is maintained at atmospheric pressure, in other words, about one atmosphere. The atmospheric pressure is not a static pressure, and can fluctuate with time, temperature, and atmospheric composition. The atmospheric composition may match the composition of the atmosphere that surrounds the earth at or near ground level.

However, the atmospheric composition and temperature or other conditions in the environment immediately surrounding the atmospheric plasma generator 106 may differ from the conventional parameters. Thus, in some exemplary embodiments, the plasma treatment zone may be maintained at a pressure from 1×10⁻⁶ atmosphere to 10 atmospheres.

Therefore, atmospheric pressure is intended to encompass standard atmospheric pressure of one atmosphere (around 14.7 psi) or any other pressure more or less than one atmosphere, as long as the pressure is the same as the pressure of the environment immediately surrounding the atmospheric plasma generator 106.

Any suitable atmospheric plasma reactor can be used as the atmospheric plasma generator 106. Energy controller 122 supplies energy input 124 to the atmospheric plasma generator 106 to generate the plasma-generating discharge 104. The energy may be electrical energy, or any other energy useful for generating the plasma-generating discharge 104. In an embodiment, the plasma-generating discharge 104 is in the form of an electrical discharge generated between optional electrical discharge electrodes 112a and 112b.

In an embodiment, the atmospheric plasma generator 106 provides a reaction chamber having a capacitively-coupled system, with at least one electrical discharge electrode 112a powered by a radio-frequency (RF) source and at least one electrical discharge electrode 112b at ground. Regardless of the specific type, such a chamber may provide an environment which allows for the control of, among other things, pressure, the flow of various inert and reactive gases, voltage supplied to the powered electrode, strength of the electric field across an ion sheath formed in the chamber, formation of a plasma-containing reactive species, intensity of ion bombardment, rate of deposition, and so on.

In an RF-generated plasma, energy is coupled into the plasma through electrons. The plasma acts as the charge carrier between the electrodes. The plasma can fill the entire reaction chamber and is typically visible as a colored cloud. The ion sheath appears as a darker area around one or both electrodes. In a parallel plate reactor using RF energy, the applied frequency is preferably in the range of about 0.001 Megahertz (MHz) to about 100 MHz, preferably about 13.56 MHz or any whole number multiple thereof. This RF power creates a plasma from the gas within the chamber. The RF power source can be an RF generator such as a 13.56 MHz oscillator connected to the powered electrode via a network that acts to match the impedance of the power supply with that of the transmission line and plasma load (which is usually about 50 ohms so as to effectively couple the RF power). Hence this is referred to as a matching network. In an embodiment, the energy controller 122 includes a matching network comprising the energy input 124, electrodes 112a and 112b.

In various embodiments, the energy controller 122 provides a suitable energy input 124, and the atmospheric plasma generator 106 is configured to generates plasma-generating discharge 104 in the form of at least one of electric discharge, spark discharge, gliding arc discharge, corona discharge, pulsed corona discharge, radio frequency plasma discharge, microwave frequency discharge, glow discharge, diffuse barrier discharge, atmospheric pressure jet discharge, or any other discharge suitable to generate atmospheric plasma, including thermal and non-electrically generated plasma and discharges, and combinations thereof.

In various embodiments, the atmospheric plasma generator 106 generates reactive species flow 108 by subjecting the precursor gas 102 to the plasma-generating discharge 104. The reactive species flow 108 includes reactive oxygen species and plasma species. Without being bound by theory, it is thought that the oxidative gas 120 contributes to the formation of the reactive oxygen species, while the carrier gas 118 contributes to the formation of the plasma species. The reactive species flow 108 therefore may contain reactive species that include electrons, ions, neutral molecules, free radicals, and other excited state atoms and molecules.

In various embodiments, the reactive species flow 108 exits the atmospheric plasma generator 106 through the aperture 110. The aperture 110 may assume any shape, geometry or configuration that allows the reactive species flow 108 to depart from or exit from the atmospheric plasma generator 106. In an embodiment, the aperture 110 is in form of a linear slit. In other embodiments, the aperture 110 is in form of a non-linear slit, such as curved, jagged, sinusoidal, or any other non-linear geometry. The slit may be narrow or wide.

In an embodiment, the aperture 110 includes a plurality of openings. The openings may be slits, circles, ovals, or any other suitable openings. In another embodiment, the aperture 110 includes a mesh or shower-head openings. In an embodiment, the aperture 110 is part of the surface of the atmospheric plasma generator 106. In another embodiment, the atmospheric plasma generator 106 includes an output module, and the aperture 110 is part of the output module. In various embodiments, the output module may be in the form of pipes, tubes, or any other geometry that can transport or convey the reactive species flow 108 out of the atmospheric plasma generator 106.

In an embodiment, the reactive species flow 108 includes an individual or single flow, beam or stream. In another embodiment, the reactive species flow 108 includes multiple flows, streams or beams. In various embodiments, the reactive species flow 108 is transported to the reinforcing fiber 126. In various embodiments, the transportation of the reactive species flow 108 to the reinforcing fiber 126 is may be carried out through diffusion, natural convection, forced convection, a forced flow, diffuse flow, fanned flow, driven flow or any other suitable form of transportation. In various embodiments, the reactive species flow 108 is not shielded from the surrounding atmosphere while being transported to the reinforcing fiber 126. In various embodiments, the reactive species flow 108 is shielded from the surrounding atmosphere while being transported to the reinforcing fiber 126. In an embodiment, the reactive species flow 108 may be shielded by transporting in at least one pipe, tube or other walled conveying mechanism.

Composite materials typically comprise a matrix and reinforcing fiber. Reinforcing fiber is laid in an uncured matrix precursor, and the matrix precursor is cured to form the composite material comprising reinforcing fiber embedded within the cured matrix. Carbon fiber composites are composites containing carbon fiber as reinforcing fiber and a resin such an epoxy resin as a matrix.

The reinforcing fiber 126 can be any fiber suitable as a reinforcing fiber in composite materials, the fiber being susceptible to functionalizing with surface oxygen. In various embodiments, the reinforcing fiber 126 is one of carbon fiber, glass fiber, wholly aromatic polyamide fibers (i.e., ARAMID fibers), polyester fiber, polymer or plastic fiber, natural fibers (e.g. cotton fibers) or any other suitable fiber.

The reinforcing fiber 126 can be an individual strand of fiber. The reinforcing fiber 126 may be a member of a fiber tow or bundle of fiber. The tow or bundle may be compacted or spread apart. The reinforcing fiber 126 may be mobile or stationary with respect to the atmospheric plasma generator 106. The reinforcing fiber 126 may be a member of a woven or nonwoven mat of fiber. The reinforcing fiber 126 may be part of a warp or weft of a weave.

The reinforcing fiber 126 may be sized or unsized. In various embodiments, no additional desizing step, including chemical or mechanical desizing, is required even when the reinforcing fiber 126 is a sized fiber, for instance, a sized carbon fiber. In other exemplary embodiments, the untreated fiber has a sizing material on at least a portion of an exterior surface of the untreated fiber, and the atmospheric plasma treatment removes a substantial amount (i.e., 95% by weight or more) of the sizing so that the treated fiber is substantially free of the sizing material.

The reinforcing fiber 126 is exposed to the reactive species flow 108 for a treatment time. In various embodiments, the reactive oxygen species within the reactive species flow 108 functionalize the reinforcing fiber 126, incorporating oxygen at the surface of the reinforcing fiber 126. The treatment time is sufficient to incorporate sufficient oxygen such that at least one of the composite matrix interfacial adhesion of the reinforcing fiber 126 or a composite matrix interfacial strength of the reinforcing fiber 126 increases. The treatment time has to be sufficiently long to allow the functionalization of the reinforcing fiber 126. However, the treatment time should be sufficiently short to prevent surface degradation of the reinforcing fiber 126. It may be desirable to use short treatment times for expediting the treatment of the reinforcing fiber 126 to allow rapid continuous treatment or processing.

The treatment time is preferably more than about 0.01 seconds, and less than about 10 minutes, more preferably, more than about 0.01 seconds, and less than about 5 minutes, and most preferably, more than about 0.1 seconds and less than about 1 minute. The treatment time may be any other suitable time depending on the nature of the reinforcing fiber 126, the nature of the plasma discharge 104, the intended composite application, and the respective compositions of the carrier gas 118, the oxidative gas 120 and the precursor gas 102.

In general, plasma discharges may degrade fibers by physical, chemical, electrical, mechanical actions or by their combinations. Further, the concentration of ionic or charged species and other potentially degrading species in the vicinity of plasma discharge may be high enough to potentially degrade or damage or impart undesirable properties to fiber placed very near the plasma discharge. Plasma discharges may also be accompanied by secondary discharges, or other fiber-degrading discharges such as filamentary discharges that can damage or degrade or otherwise undesirably affect the properties of the reinforcing fiber 126 on contact.

To avoid such damage, in various embodiments, the reinforcing fiber 126 is at least maintained at a non-degrading distance from the plasma-generating discharge 104, such that any fiber-degrading discharge, including the plasma-generating discharge 104, or any filamentary discharge or other discharge generated by the atmospheric plasma generator 106 that can damage the reinforcing fiber 126 on contact fails to contact the reinforcing fiber 126. In various embodiments, the non-degrading distance depends on the nature of the reinforcing fiber 126, the plasma discharge 104, the atmospheric plasma generator 106, the precursor gas 102 and the energy input 124.

In one particular exemplary embodiment, the non-degrading distance is at least about 1 mm, preferably about 5 mm, more preferably about 10 mm, even more preferably about 5 cm, and most preferably about 10 cm. The non-degrading distance can also be any distance within these ranges or beyond these ranges, as long as the non-degrading distance is short enough to permit an effective concentration of reactive oxygen species within the reactive species flow 108 to arrive at the reinforcing fiber 126.

In other embodiments, damage to fiber is avoided by shielding the reinforcing fiber 126 from the plasma-generating discharge 104 by placing a discharge barrier which allows the reactive species flow 108 to flow past, but prevents stray or unwanted discharge from passing the discharge barrier. The discharge barrier may take the form of a screen, a mesh, a Faraday cage, or other solid or permeable or semi-permeable barrier or combinations thereof between the plasma-generating discharge 104 and the reinforcing fiber 126. In embodiments where the discharge barrier is deployed, the non-degrading distance may be shorter than in embodiments where no discharge barrier is used.

Referring now to FIG. 1B, a reactive species flow 108b is generated by an atmospheric plasma generator 106b, exiting through an aperture 110b. A reinforcing fiber 126b is exposed to the reactive species flow 108b for a treatment time. In various embodiments, the reactive species flow 108b and a portion or a part or a surface of the reinforcing fiber 126b being exposed to the reactive species flow 108b are contained in a plasma treatment zone 130b surrounded by a treatment zone shield 128b formed by a curtain of shielding gases flowing parallel to, and surrounding the reactive species flow 108b and the part of the reinforcing fiber 126b being exposed to the reactive species flow 108b.

The treatment zone shield 128b shields the exposed part of the reinforcing fiber 126b and the reactive species flow 108b from the surrounding atmosphere (not shown). Such shielding may lead to enhanced treatment by preventing unwanted interaction from atmospheric components with the reactive species flow 108b and/or the reinforcing fiber 126b before, during, or after the treatment.

Any suitable flowing inert or semi-inert gases such as those used as shielding gases in welding applications, for instance, helium, argon, air, nitrogen, oxygen, carbon dioxide, water vapor, or any other suitable shielding gas or their combinations thereof may be used to form the treatment zone shield 128b. The flow rate of the shielding gases may be adjusted depending on parameters such as the composition and nature of the surrounding atmosphere and the composition, nature and flow conditions of the reactive species flow 108b. In general, the flow rate would be sufficiently high to reduce the flow of the surrounding atmosphere into the plasma treatment zone 130b or prevent the surrounding atmosphere from entering the plasma treatment zone 130b.

Referring now to FIG. 1C, a reactive species flow 108c is generated by an atmospheric plasma generator 106c, exiting through an aperture 110c. A reinforcing fiber 126c is exposed to the reactive species flow 108c for a treatment time. In various embodiments, the reactive species flow 108c and a portion or a part or a surface of the reinforcing fiber 126c being exposed to the reactive species flow 108c are contained in a plasma treatment zone 130c surrounded by a treatment zone shield 128c′ formed by an enclosure surrounding the reactive species flow 108c and the part of the reinforcing fiber 126′ being exposed to the reactive species flow 108c.

The treatment zone shield 128c shields the exposed part of the reinforcing fiber 126c and the reactive species flow 108c from the surrounding atmosphere (not shown). Such shielding may lead to enhanced treatment by preventing unwanted interaction from atmospheric components with the reactive species flow 108c and/or the reinforcing fiber 126c before, during, or after the treatment. The enclosure may be formed of any material such as a solid, permeable, semi-permeable barrier including metals, plastics, paper, fabric, foils, screens, mats, nonwoven materials, or any other material that will reduce or prevent the flow of the surrounding atmosphere into the plasma treatment zone 130c.

Referring now to FIG. 1D, a reactive species flow 108d is generated by an atmospheric plasma generator 106d, exiting through an aperture 110d. A reinforcing fiber 126d is exposed to the reactive species flow 108d for a treatment time. In various embodiments, the reactive species flow 108d and a portion or a part or a surface of the reinforcing fiber 126d being exposed to the reactive species flow 108d are contained in a plasma treatment zone 130d surrounded by a treatment zone shield 128d formed by an enclosure surrounding the reactive species flow 108d and the part of the reinforcing fiber 126d being exposed to the reactive species flow 108d.

The treatment zone shield 128d shields the exposed part of the reinforcing fiber 126d and the reactive species flow 108d from the surrounding atmosphere (not shown). Such shielding may lead to enhanced treatment by preventing unwanted interaction from atmospheric components with the reactive species flow 108d and/or the reinforcing fiber 126d before, during, or after the treatment. The enclosure may be formed of any material such as a solid, permeable, semi-permeable barrier including metals, plastics, paper, fabric, foils, screens, mats, nonwoven materials, or any other material that will reduce or prevent the flow of the surrounding atmosphere into the plasma treatment zone 130.

In various exemplary embodiments, the plasma treatment zone 130d is purged by passing inlet purge gas 132d into the plasma treatment zone and/or allowing outlet purge gas 134d to exit the plasma treatment zone 130d. In various embodiments, the inlet purge gas 132d includes a suitable inert or semi-inert gas such as helium, argon, air, nitrogen, oxygen, carbon dioxide, water vapor, or any other suitable purge gases or their combination thereof. In some embodiments, the outlet purge gas 134d includes reactive species flow 108d exiting the plasma treatment zone 130d.

In other embodiments, the outlet purge gas 134d substantially includes the inlet purge gas 132d exiting the plasma treatment zone 130d. In still further embodiments, the outlet purge gas 134d includes both the inlet purge gas 132d and the reactive species flow 108d exiting the plasma treatment zone 108. In one particular exemplary embodiment, the inlet purge gas 132d and/or the outlet purge gas 134d are treated by filtration, adsorption, absorption, or other suitable gas treatments.

In other exemplary embodiments, the present disclosure provide a method of fabricating a fiber-reinforced composite using any of the foregoing methods for treating reinforcing fibers. In some exemplary embodiments, the fiber-reinforced composite includes a multiplicity of treated reinforcing fibers selected from carbon fibers, ceramic fibers, glass fibers, (co)polymeric fibers, natural fibers, or a combination thereof. In certain exemplary embodiments, the multiplicity of treated reinforcing fibers includes a fiber tow.

In further exemplary embodiments, the present disclosure provides a fiber-reinforced composite including the treated reinforcing fiber produced according to any of the foregoing treatment methods. The fiber-reinforced composite may be selected from an uncured fiber-reinforced pre-preg composite, a partially-cured fiber-reinforced composite, or a fully-cured fiber-reinforced composite.

The operation of various embodiments of the present disclosure will be further described with regard to the following detailed examples. These examples are offered to further illustrate the various specific and preferred embodiments and techniques. It should be understood, however, that many variations and modifications may be made while remaining within the scope of the present disclosure.

### EXAMPLES

These Examples are merely for illustrative purposes and are not meant to be overly limiting on the scope of the appended claims. Notwithstanding that the numerical ranges and parameters setting forth the broad scope of the present disclosure are approximations, the numerical values set forth in the specific examples are reported as precisely as possible. Any numerical value, however, inherently contains certain errors necessarily resulting from the standard deviation found in their respective testing measurements. At the very least, and not as an attempt to limit the application of the doctrine of equivalents to the scope of the claims, each numerical parameter should at least be construed in light of the number of reported significant digits and by applying ordinary rounding techniques.

### Materials

Unless otherwise noted, all parts, percentages, ratios, etc. in the Examples and the rest of the specification are by weight. Solvents and other reagents used may be obtained from Sigma-Aldrich Chemical Company (Milwaukee, Wis.) unless otherwise noted. In addition, Table 1 provides abbreviations and a source for all materials used in the Examples below.

TABLE 1
Materials

| Abbreviation | Description | Source |
|---|---|---|
| T700-24K | Carbon Fiber T700-24K | Toray Carbon Fibers |
| | (Unsized) | America, Flower |
| | | Mound, TX |
| T700-24K-50C | Carbon Fiber T700-24K | Toray Carbon Fibers |
| | with SC Sizing | America, Flower |
| | | Mound, TX |
| TRH50-18K | Intermediate Modulus | Grafil, Inc., |
| | Carbon Fiber (Unsized) | Sacramento, CA |
| NEXTEL 610 | Alpha Aluminum Oxide | 3M Company, St. |
| Amino-sizing | Fibers with Amino- | Paul, MN |
| | functional silane/ | |
| | EPIREZ 500 organic | |
| | sizing | |
| NEXTEL 610 | Alpha Aluminum Oxide | 3M Company, St. |
| Epoxy-sizing | Fibers with Epoxy- | Paul, MN |
| | functional Silane | |
| | EPIREZ organic | |
| | sizing for use with | |
| | epoxy resins | |
| Glass Fibers | Fiberglass Roving | Available from Fibre |
| | Clean V | Glast Developments, |
| | | Inc., Brookville, OH |
| EPON 828 | A Diglycidyl Ether | Momentive Specialty |
| | of Bisphenol A having | Chemical, Inc., |
| | an Epoxy Equivalent | Houston, TX |
| | Weight of 188 | |
| LINDRIDE 6K | Isomeric form of | Lindau Chemicals, |
| | Methyltetrahydrophthalic | Inc., SC |
| | Anhydride | |
| LINDRIDE 36V | Isomeric form of | Lindau Chemicals, |
| | Methyltetrahydrophthalic | Inc., SC |
| | Anhydride | |
| HELOXY 505 | Low Viscosity Polyepoxide | Momentive Specialty |
| | Resin | Chemical, Inc., |
| | | Houston, TX |
| HELOXY 107 | Diglycidyl Ether of | Momentive Speciality |
| | Cyclohexane Dimethanol | Chemical, Inc., |
| | | Houston, TX |
| 3M Matrix Resin | Nanoparticle Filled Resin | 3M Company, St. |
| 4831 | System | Paul, MN |

### Test Methods

The following test methods have been used in evaluating some of the Examples of the present disclosure.

### Single Fiber Fragmentation Test (SFFT)

Inter-laminar shear strength between the reinforcing fiber and the composite matrix was measured using a single fiber fragmentation test. The single fiber was placed in a dog-bone shaped silicone mold (25.4 mm gauge length) under 10 g tension. The mold was then filled with the resin system (5 g EPON 828, 5 g HELOXY 505, 5 g LINDRIDE 6K) and cured at 93° C. for 2 hours followed by 2 hours at 204° C. The cured resin had a tensile strain much higher than the fiber, so that resin did not break before reaching the fiber's ultimate strength. These samples were strained at the rate of 5 mm/min until the resin yields and pictures of the strained specimen were taken to measure the fiber fragmentation length.

The critical fragmentation length (l_{c}) is calculated to be 75% of the average fiber fragmentation length (lav_{g}). The interfacial shear strength between the fiber and the matrix is given by Kelly-Tyson model. (Kelly, A and Tyson, W R. 1965. Tensile Properties of Fibre-reinforced Metals: Copper/tungsten and Copper/molybdenum., J. Mech. Phys. Solids, 13: 329-3501), as shown in the following equation:

$$τ = \frac{{σ}_{f}}{2} ( \frac{d}{{l}_{c}} )$$

### Where:

τ: average shear strength
σ_{f}: fiber tensile strength
d: fiber diameter
l_{:c}: critical length

From the preceding equation, it follows that the lower the fragmentation length, the higher is the interfacial adhesion between the epoxy resin and the composite matrix.

### Single Fiber Tensile Strength (SFTS)

The single fiber tensile strength of the reinforcing fiber was measured according to ASTM C1557-03. Single carbon fibers were laid on a cardboard frame with to give a gauge length of 25.4 mm. The final load required to fail the specimen was noted. The tensile load to failure was calculated as the average of the load values in a given set.

### XPS Surface Analysis

Fiber surfaces before and after treatment were examined using X-ray Photoelectron Spectroscopy (XPS) also known as Electron Spectroscopy for Chemical Analysis (ESCA). This technique provides an analysis of the outermost 3 to 10 nanometers (nm) on the specimen surface. The photoelectron spectra provide information about the elemental and chemical (oxidation state and/or functional group) concentrations present on a solid surface. XPS is sensitive to all elements in the periodic table except hydrogen and helium with detection limits for most species in the 0.1 to 1 atomic % concentration range. The apparent concentrations of surface groups determined using XPS were calculated using the instrument-maker-supplied relative sensitivity factors and should be considered semi-quantitative.

TABLE 2
Surface Analysis Conditions

| Instrument | Physical Electronics Quantera II ™ |
|---|---|
| Analysis Area | ≈500 μm × 1500 μm |
| | Averaging over multiple fiber bundles |
| Photoelectron Take-off Angle | 45° ± 20° solid angle of acceptance |
| X-ray Source | Monochromatic Al Kα (1486.6 eV) 85 W |
| Charge Neutralization | Low energy e⁻ and Ar⁺ flood sources |
| Charge Correction | C 1s C—C, H feature to 284.6 eV |
| Analysis Chamber Pressure | <3 × 10⁻⁸ Torr (4 × 10⁻⁶ Pa) |

### Short Beam Shear Strength (SBSS)

Short beam shear strength of sample composite was measured using the method outlined in ASTM D2344-00. Composite sample rings were made by unwinding the fiber spool, treating the fibers, coating them in a resin bath (3M 4831 Matrix Resin/LINDRIDE 6K-100/47 by weight) and wound on a ½ inch with mandrel with inner diameter of 5.65 inch to build up a thickness of ˜6 mm. The composite was then cured on the mandrel in the oven at 90° C. for 2 hours followed by 150° C. for 2 hours. Small composite components are cut out of the specimen as described in ASTM D2344-00 and then tested under bending load. The average of the failure mode is reported as short beam shear strength with the standard deviation values.

### Experimental Apparatus

### Atmospheric Plasma Generator

Atmospheric plasma (AP) was generated using a linear treatment head (SURFX Atomflo 400 system with a 2-inch (5.08 cm) linear head). The treatment head contains an input for gases, electrodes to generate electric discharge that can break down susceptible gases into plasma, and an opening for blowing the treated gases out, in the form of a linear slit. Precursor gases are input to the treatment head. The gases input to the treatment head pass through a plasma-generating discharge between electrodes, and an output flow of gases containing reactive species is generated. The output flow is blown through the opening in the treatment head.

### Comparative Example 1 (C-1)

### Untreated Sized Carbon Fibers

The SFFT test as described above was performed on the untreated sized T700-24K-50C fibers. The critical fragmentation length (l_{c}) was found to be 366 microns. The single fiber tensile strength was found to be 0.16 N.

The XPS Surface Analysis test on the untreated sized T700-24K-50C fibers indicated a surface oxygen concentration of 22% with oxygen/carbon ratio of 0.28. The high resolution XPS C1s spectrum of the sized fibers included a strong contribution at ˜286.3 eV binding energy from C—O bonded carbon (consistent with ether, epoxy, alcohol and/or similar) along with a similar sized feature from C—C,H bonded carbon.

### Comparative Example 2 (C-2)

### Untreated Heated Sized Carbon Fibers

T700-24K-50C fibers were subjected to high temperature treatment (450° C. for 30 minutes in N₂ atmosphere) to remove the sizing, as indicated by the XPS Surface Analysis test. After heating, the XPS surface % O was ˜10%, the C1s C—O peak was greatly diminished and the XPS C1s spectrum was dominated by an asymmetric peak similar to that of graphitic or amorphous carbon. A characteristic high resolution N1s feature, peaked at ˜401 eV with weaker components at ˜400 eV and ˜398.5 eV was also observed. These components are attributed to N in graphitic, pyrrolic and pyridinic bonding configurations within the charred PAN fiber material.

The SFFT test as described above was also performed on the unsized T700-24K fibers. The SFFT critical fragmentation length (l_{c}) was found to be 500 microns.

### Example 1

### AP Plasma Treatment of Unsized Carbon Fibers

Unsized T700-24K carbon tow was passed under the linear slit of the plasma treatment head of the AP plasma generator at a distance of 6.35 mm from the surface, at a speed of 0.2 m/min. Input gases contained 0.85 L/min of oxygen and 30 L/min of Helium with a 180 W electric supply applied between the electrodes.

The resulting AP plasma treated carbon fibers were subjected to the SFFT and SFTS tests. The SFFT critical fragmentation length (l_{c}) of the resulting treated fiber was 160 microns, compared to 366 microns for the sized and untreated fibers, suggesting better adhesion between the matrix and fiber after treatment. Also, the SFTS tensile strength of the fiber was found to be similar to untreated and sized fiber (0.16 N in both cases) suggesting minimum fiber damage.

The AP plasma treated carbon fibers were also subjected to the XPS Surface Analysis test. The XPS surface oxygen concentration was 24% with an oxygen/carbon ratio of 0.34. While the surface O concentration returned to a value similar to that of the sized fibers after treatment, the types of bonds present were different, having a greater proportion of the C bonded in carboxyl forms and much less in C—O forms.

### Example 2

### AP Plasma Treatment of Sized Carbon Fibers

Example 2 is similar to Example 1 except that a sized carbon fiber tow, T700-24K-50C, was subjected to the identical AP plasma treatment as in Example 1.

The resulting AP plasma treated carbon fibers were subjected to the SFFT and SFTS tests. The critical length (la) of the resulting fiber is 151 microns compared to 366 microns suggesting better adhesion between the fiber and the matrix. Also the single fiber tensile strength of the fiber was found to be similar to untreated and sized fiber (0.16 N in both cases) suggesting minimum fiber damage.

The AP plasma treated carbon fibers were also subjected to the XPS Surface Analysis test. The XPS surface oxygen concentration was 24% with an oxygen/carbon ratio of 0.33. When the surface of the fiber was analyzed immediately after treatment, the XPS surface oxygen concentration was 34% with an oxygen/carbon ratio of 0.58. While the surface O concentration returned to a value similar to that of the sized fibers after treatment, the types of bonds present were different, having a greater proportion of the C bonded in carboxyl forms and much less in C—O forms. The surface oxidation was spectrally very similar to that obtained by treating heated, unsized fibers.

### Example 3

### AP Plasma on Sized Carbon Fibers

Example 3 is similar to Example 2 except that the speed under the plasma head was 4.7 m/min.

The resulting AP plasma treated carbon fibers were subjected to the SFFT and SFTS tests. The SFFT critical length (l_{c}) was found to be 319 compared to 366 microns for the sized and untreated fibers, suggesting better adhesion after treatment. Also the single fiber tensile strength of the fiber is found to be similar to untreated and sized fiber (0.16 N in both cases) suggesting minimum fiber damage.

### Example 4

### AP Plasma on Sized Carbon Fibers

Example 4 is similar to Example 2 except that the speed under the plasma head was 2 m/min.

The resulting AP plasma treated carbon fibers were subjected to the SFFT and SFTS tests. The SFFT critical length (l_{c}) was found to be 252 compared to 366 microns for the sized and untreated fibers, suggesting better adhesion after treatment. Also the single fiber tensile strength of the fiber is found to be similar to untreated and sized fiber (0.16N in both cases) suggesting minimum fiber damage.

### Example 5

### AP Plasma on Sized Carbon Fibers with Argon Carrier Gas

Sized carbon fiber tow (T700-24K-50C) was kept at a distance of 6.35 mm from the surface of the plasma treatment head of the AP plasma generator and passed under the head at a speed of 0.2 m/min. The input gases contained 0.4 L/min of oxygen and 20 L/min of Helium with a 160 W power applied between the electrodes.

The resulting AP plasma treated carbon fibers were subjected to the SFFT and SFTS tests. The SFFT critical length (l_{c}) is found to be 320 compared to 366 microns for the sized and untreated fibers, suggesting better adhesion after treatment.

The AP plasma treated carbon fibers were also subjected to the XPS Surface Analysis test. The XPS surface analysis showed that the oxygen content was 25% and an oxygen/carbon ratio of 0.34.

### Example 6

### AP Plasma on Carbon Fibers at Lower Oxygen Concentration

Example 6 is similar to Example 2 except that the oxygen concentration in the carrier gas was 0.43 L/min. The AP plasma treated carbon fibers were subjected to the XPS Surface Analysis test. The XPS surface analysis showed that the oxygen content was 20% and an oxygen/carbon ratio of 0.27.

### Example 7

### AP Plasma on Carbon Fibers at Lower Oxygen Concentration

Example 7 is similar to Example 2 except that the carrier gas contained 0.85 L/min of air instead of oxygen. The AP plasma treated carbon fibers were subjected to the XPS Surface Analysis test. The XPS surface analysis showed that the oxygen content was 25% and an oxygen/carbon ratio of 0.36.

### Example 8

### AP Plasma on TRH50-18K

Example 8 is similar to Example 2 except that the fibers treated were TRH50-18K fibers. The AP plasma treated carbon fibers were subjected to the XPS Surface Analysis test. When the surface of the fiber was analyzed immediately after treatment, the XPS surface oxygen concentration was 19% with an oxygen/carbon ratio of 0.26. While the surface O concentration returned to a value similar to that of the sized fibers after treatment, the types of bonds present were different, having a greater proportion of the C bonded in carboxyl forms and much less in C—O forms. Also, the nitrogen species present were more graphitic in nature compared to organic nitrogen present in the sized fibers.

### Comparative Example 3 (C-3)

### Corona Treated Carbon Fibers

T700-24K-50C carbon fibers were treated in a “Universal” model corona treater manufactured by Pillar Technologies of Hartland, Wis. The fibers were placed on the drum and passed through a corona discharge energy of 20 J/cm². The fibers were found to be burnt at the end of the treatment and the final strength of the fibers using the SFFT test method was found to be lower than the initial strength.

### Comparative Example 4 (C-4)

### Vacuum Plasma Treated Carbon Fibers

T700-24K-50C carbon fibers were treated in a vacuum plasma chamber with O₂ (500 Sccm) and 500 W power for 30 sec. Visual inspection revealed that the fibers looked damaged after vacuum plasma treatment. The fiber strength was found to be lower than the initial strength before treatment using the SFFT test method.

### Comparative Example 5 (C-5)

### Blown Air Plasma Treated Carbon Fibers

T700-24K-50C carbon fibers were treated in a PlasmaTreat FLUME Jet, Model RD1004, at a power of approximately 1400 Watts, with 2 cm spacing between the tip of the plasma device and the target carbon fiber. The fibers visually looked damaged at the end of the run. Also, the filamentary nature of the discharge scorched the fibers and reduced the strength of the fiber after treatment. Table III summarizes representative test results obtained for certain of the foregoing Examples and Comparative Examples carried out using carbon fibers.

TABLE III
Test Results for Examples 1-7 and Comparative Examples C1-C2

| Property | Ex 1 | Ex 2 | Ex 3 | Ex 4 | Ex 5 | Ex 6 | Ex 7 | C 1 | C 2 |
|---|---|---|---|---|---|---|---|---|---|
| Critical | 160 | 151 | 319 | 252 | 320 | — | — | 366 | 500 |
| Fragmentation | | | | | | | | | |
| Length, lc | | | | | | | | | |
| (Microns) | | | | | | | | | |
| Single Fiber | 0.16 | 0.16 | 0.16 | 0.16 | 0.16 | 0.16 | 0.16 | 0.16 | 0.16 |
| Tensile | | | | | | | | | |
| Strength, (N) | | | | | | | | | |
| Surface | 34 (no | 24 | — | — | 25 | 20 | 25 | 21 | 10 |
| Analysis, | aging); | | | | | | | | |
| Oxygen Content | 24 (after | | | | | | | | |
| (%) | two | | | | | | | | |
| | weeks) | | | | | | | | |
| Apparent | —COOH | —COOH | —COOH | —COOH | —COOH | | | —C—O | Little |
| Oxygen- | | | | | | | | | Oxygen |
| containing | | | | | | | | | Present; |
| Species Present | | | | | | | | | Mostly |
| | | | | | | | | | Graphitic |
| | | | | | | | | | Carbon |
| Apparent | Graphitic, | Graphitic, | Graphitic, | Graphitic, | Graphitic, | | | Organic | Graphitic, |
| Nitrogen- | Pyrrolic | Pyrrolic | Pyrrolic | Pyrrolic | Pyrrolic | | | Nitrogen | Pyrrolic |
| containing | and | and | and | and | and | | | Species | and |
| Species | Pyridinic | Pyridinic | Pyridinic | Pyridinic | Pyridinic | | | | Pyridinic |
| Present | | | | | | | | | |

### Examples of Treated Fibers Used in a Composite

### Comparative Example 6 (C-6)

### Untreated Sized Carbon Fibers in a Composite

Composite sample rings were made by unwinding the fiber spool (T700-24K-50C sizing), coating them in a resin bath (3M 4831 Matrix Resin/LINDRIDE 6K-100/47 by weight) and winding on a ½ inch reel with mandrel with inner diameter of 5.65 inch (about 14.35 cm) to build up a thickness of ˜6 mm. The composite was then cured on the mandrel in the oven at 90° C. for 2 hours followed by 150° C. for 2 hours.

The Short Beam Shear Strength (SBSS) test method was carried out on the composite prepared using the untreated sized carbon fibers. The SBSS of the composite was found to be 60 MPa.

### Example 9

### AP Plasma Treated Carbon Fibers in a Composite

Composite samples were made using the method described in C-2 except that the carbon fibers were treated with the SURFX plasma system. The carrier gas had 0.85 L/min of oxygen and 30 L/min of He gas just before coating the fibers with the resin.

The SBSS test method was carried out on the composite prepared using the treated carbon fibers. The SBSS strength of the composite was found to be 73 MPa compared to 60 MPa for the composite with treated fiber. Table IV summarizes the short beam shear strength test results for Example 9 and Comparative Example 6.

TABLE IV
Composite Strength for Example 9 and Comparative Example 6

| | Ex 9 | C6 |
|---|---|---|
| Short Beam Shear Strength (MPa) | 73 ± 5 | 60 ± 3.4 |

### Examples of Removal of Sizing from Untreated Fibers by AP Plasma Treatment

### Comparative Example 7 (C-7)

### Untreated Sized Carbon Fibers

XPS was used to evaluate the surface chemistry of the untreated T700-24K-50C sized carbon fibers. The XPS analysis indicated a surface oxygen concentration of 22% with oxygen/carbon ratio of 0.28. The high resolution XPS C1s spectrum of the sized fibers included a strong contribution at ˜286.3 eV binding energy from C—O bonded carbon (consistent with ether, epoxy, alcohol and/or similar) along with a similar sized feature from C—C,H bonded carbon.

### Example 10

### AP Plasma Treated Sized Carbon Fibers

A T700-24K-50C sized fiber tow was passed under the linear slit of the plasma treatment head at a distance of 2 mm from the surface, at a speed of 0.2 m/min. Input gases contained 0.85 L/min of oxygen and 30 L/min of Helium with a 180 W electric supply applied between the electrodes.

XPS was used to evaluate the surface chemistry of the treated T700-24K-50C carbon fibers. The XPS surface oxygen concentration was 24% with an oxygen/carbon ratio of 0.33. While the surface O concentration returned to a value similar to that of the sized fibers after treatment, the types of bonds present were different, having a greater proportion of the C bonded in carboxyl forms and much less in C—O forms indicating substantial removal of the organic sizing coating from the surface of the fiber.

Single tow tensile tests were performed on AP plasma treated T700-24K tows prepared according to Example 10 and impregnated with 3M 4831 epoxy resin (available from 3M Company, St. Paul, Minn.). The tensile strength of the carbon fibers did not decrease after AP plasma treatment to substantially remove the sizing material. An increase in the overall tensile strength was observed after treatment of the fiber because of better interfacial strength between fiber and the matrix owing to better stress transfer within the composite.

### Comparative Examples C-8 and C-9

### Untreated Sized NEXTEL Ceramic Fibers

The surface chemistries of untreated sized NEXTEL 610 Amino-sizing and NEXTEL 610 Epoxy-sizing alpha-alumina ceramic fibers were evaluated using the XPS Surface Analysis method before treatment with the atmospheric plasma treatment. The Si was consistent with silicone/silicate/silane for the untreated controls. Nitrogen was predominantly present in organic forms before treatment. The untreated NEXTEL 610 Amino-sizing and NEXTEL 610 Epoxy-sizing alpha-alumina ceramic fibers also showed substantial levels of surface organic material that included significant C—O bonding (ethers, alcohols, epoxies). The 0 is was dominated by C—O forms before treatment. Both types of fibers also had low level Si present on control surfaces with Si 2p binding energies consistent with silicone/silicate/silane. The XPS results are summarized in Table V.

TABLE V
XPS Surface Concentrations for Untreated and Treated Sized NEXTEL Fibers
(Average of 6 Measurements)

| Example | Fiber Type | Condition | C | N | O | Na | Al | Si | Si/Al |
|---|---|---|---|---|---|---|---|---|---|
| C8 | NEXTEL 610 | Untreated | 66 | 0.4 | 27 | 0.0 | 4.6 | 1.7 | 0.4 |
| | ceramic fibers with | Control | | | | | | | |
| | Amino-sizing | | | | | | | | |
| 11 | NEXTEL 610 | AP Plasma | 13 | 0.6 | 61 | 0.0 | 16 | 9.7 | 0.7 |
| | ceramic fibers with | Treated | | | | | | | |
| | Amino-sizing | He002 | | | | | | | |
| C9 | NEXTEL 610 | Untreated | 75 | 0.7 | 22 | 0.0 | 2.1 | 0.8 | 0.4 |
| | ceramic fibers with | Control | | | | | | | |
| | Epoxy-sizing | | | | | | | | |
| 12 | NEXTEL 610 | AP Plasma | 15 | 0.8 | 60. | 0.1 | 15 | 9.4 | 0.6 |
| | ceramic fibers with | Treated | | | | | | | |
| | Epoxy-sizing | He002 | | | | | | | |

### Examples 11-12

### AP Plasma Treated Sized NEXTEL Ceramic Fibers

NEXTEL 610 Amino-sizing and NEXTEL 610 Epoxy-sizing alpha-alumina ceramic fibers were exposed to the atmospheric plasma treatment as described in Example 10.

XPS Surface Analysis was carried out on the treated NEXTEL fibers. The XPS results are summarized in Table V. The XPS analysis showed that the treated fiber surfaces had much lower levels of organics, suggesting sizing removal, and substantially higher levels of O, Al and Si. Treated fibers also had much higher levels of Al, Si and O. The Al was consistent with oxide/hydroxide. The Si on the treated fiber surfaces appeared to be consistent with silica, and the Si/Al ratios were higher than observed on the untreated controls. Quaternary/N—O bonding configurations were also apparent after treatment. Stronger contributions from Al₂O₃ were apparent after treatment. The treated surface O1s spectra also appear to contain contributions from silica/silicate/aluminum hydroxide, which overlap the organic contributions.

The remaining organics had C—C,H, C—O and O═C—O contributions with relatively weaker contributions from C—O than found on the untreated controls. The chemical signature of the remaining organic compounds on the treated NEXTEL fiber surface was similar to that of adventitious organic residues. The XPS results are summarized in Table V, above.

### Comparative Example C-10

### Untreated Sized Glass Fibers

The surface chemistry of the untreated sized glass fibers was characterized using the XPS Surface Analysis test method. The XPS results are summarized in Table VI.

The untreated sized glass fiber surface had fairly low C levels, with C in predominantly hydrocarbon form along with lower levels of C—O and O═C—O. Low level N was also present in what appeared to be an organic form. Other elements detected included B, O, Na, Mg, Al, Si, Cl, K and Ca. Some of the Si may have been present as silane, but it was not possible to distinguish this contribution from the silicate.

TABLE VI
XPS Surface Concentrations for Untreated and Treated Sized Glass Fibers
(Average of 6 Measurements)

| Glass Condition | Area | B | C | N | O | F | Na | Mg | Al | Si | Cl | K | Ca |
|---|---|---|---|---|---|---|---|---|---|---|---|---|---|
| C10 Untreated | avg. | 1.4 | 17 | 0.6 | 56 | 0.0 | 0.7 | 0.1 | 3.7 | 17 | 0.1 | 0.2 | 3.5 |
| Control | | | | | | | | | | | | | |
| Ex 13 | avg. | 1.7 | 8.9 | 0.1 | 62 | 0.1 | 1.5 | 0.2 | 3.5 | 17 | 0.2 | 0.3 | 3.7 |
| AP Plasma | | | | | | | | | | | | | |
| treated He002 | | | | | | | | | | | | | |

### Example 13

### AP Plasma Treated Sized Glass Fibers

The untreated, as-received sized glass fibers of Comparative Example 10 were exposed to the atmospheric plasma treatment as described in Example 10.

The surface chemistry of the treated glass fibers was characterized using the XPS Surface Analysis test method. The XPS results are summarized in Table V, above. XPS analysis of the treated glass fiber surface chemistry shows that the treated fiber surfaces had much lower levels of organics, suggesting sizing removal. The treated surface C levels were approximately cut in half by the treatment, with the remaining C being more highly oxidized (lower hydrocarbon and greater O═C—O contributions). The organic N present on the control fibers was also largely removed by treatment. There was some variation in relative levels of glass components with alkali and alkaline earth elements showing small gains, and aluminum showing a small decrease. The Si concentrations were nearly unchanged by plasma treatment.

Reference throughout this specification to “one embodiment,” “certain embodiments,” “one or more embodiments” or “an embodiment,” whether or not including the term “exemplary” preceding the term “embodiment,” means that a particular feature, structure, material, or characteristic described in connection with the embodiment is included in at least one embodiment of the certain exemplary embodiments of the present disclosure. Thus, the appearances of the phrases such as “in one or more embodiments,” “in certain embodiments,” “in one embodiment” or “in an embodiment” in various places throughout this specification are not necessarily referring to the same embodiment of the certain exemplary embodiments of the present disclosure. Furthermore, the particular features, structures, materials, or characteristics may be combined in any suitable manner in one or more embodiments.

While the specification has described in detail certain exemplary embodiments, it will be appreciated that those skilled in the art, upon attaining an understanding of the foregoing, may readily conceive of alterations to, variations of, and equivalents to these embodiments. Accordingly, it should be understood that this disclosure is not to be unduly limited to the illustrative embodiments set forth hereinabove. Furthermore, all publications and patents referenced herein are incorporated by reference in their entirety to the same extent as if each individual publication or patent was specifically and individually indicated to be incorporated by reference. Various exemplary embodiments have been described. These and other embodiments are within the scope of the following claims.

1. A method for treating reinforcing fiber, the method comprising:
(a) transporting a precursor gas comprising a carrier gas and an oxidative gas comprising up to 25% by volume of the precursor gas to an atmospheric plasma-generating discharge within an atmospheric plasma generator to generate a reactive species flow, the reactive species flow comprising reactive oxygenated species produced from the oxidative gas; and
(b) exposing an untreated reinforcing fiber to the reactive species flow for a treatment time sufficient to functionalize the reinforcing fiber with oxygen such that at least one of a composite matrix interfacial adhesion of the treated reinforcing fiber or a composite matrix interfacial strength of the treated reinforcing fiber, increases.

2. The method of claim 1, wherein the untreated fiber has a sizing material on at least a portion of an exterior surface of the untreated fiber, and further wherein the treated fiber is substantially free of the sizing material.

3. The method of claim 1, wherein exposing the untreated reinforcing fiber to the reactive species flow further comprises maintaining the reinforcing fiber at a distance from the atmospheric plasma-generating discharge so that the reinforcing fiber is not damaged by the atmospheric plasma-generating discharge.

4. The method of claim 1, wherein the oxidative gas comprises O₂, air, N₂O, NO₂, or a combination thereof.

5. The method of claim 1, wherein the carrier gas comprises helium, argon, or a combination thereof.

6. The method of claim 1, wherein the atmospheric plasma-generating discharge is selected from an electric discharge, a spark discharge, a gliding arc discharge, a corona discharge, a pulsed corona discharge, a radio frequency plasma discharge, a microwave frequency discharge, a glow discharge, a diffuse barrier discharge, an atmospheric pressure jet discharge, or a combination thereof.

7. The method of claim 1, wherein the treatment time is selected from 0.01 seconds to 10 minutes.

8. The method of claim 1, further comprising shielding from a surrounding atmosphere a plasma treatment zone through which the reactive species flow and the reinforcing fiber are passed.

9. The method of claim 8, wherein the shielding comprises enclosing the plasma treatment zone.

10. The method of claim 8, wherein the plasma treatment zone is maintained at a pressure from 1×10⁻⁶ atmosphere to 10 atmospheres.

11. The method of claim 8, further comprising purging the plasma treatment zone with a purge gas, wherein the purging occurs before the exposing step, during the exposing step, after the exposing step, or a combination thereof.

12. The method of claim 1, further comprising transporting the reactive gas flow from the atmospheric plasma generator to the untreated reinforcing fiber, optionally wherein the transporting comprises directing the reactive species flow towards an exterior surface of the untreated reinforcing fiber.

13. The method of claim 12, wherein the transporting further comprises shielding the reactive species flow from a surrounding atmosphere.

14. The method of claim 1, wherein a surface oxygen concentration of the treated reinforcing fiber measured using X-ray Photoelectron Spectroscopy (XPS) increases by at least 10% relative to a surface oxygen concentration of the untreated reinforcing fiber measured using XPS.

15. The method of claim 1, wherein the untreated reinforcing fiber is selected from a carbon fiber, a ceramic fiber, a glass fiber, a (co)polymeric fiber, or a natural fiber.

16. The method of claim 15, wherein the untreated reinforcing fiber is substantially free of a sizing material.

17. A method of fabricating a fiber-reinforced composite, the method comprising the method of claim 1.

18. The method of claim 17, wherein the fiber-reinforced composite comprises a plurality of treated reinforcing fibers selected from carbon fibers, ceramic fibers, glass fibers, (co)polymeric fibers, natural fibers, or a combination thereof.

19. The method of claim 18, wherein the plurality of treated reinforcing fibers comprises a fiber tow.

20. A fiber-reinforced composite comprising the treated reinforcing fiber produced using the method of claim 1, wherein the fiber-reinforced composite is selected from an uncured fiber-reinforced pre-preg composite, a partially-cured fiber-reinforced composite, or a fully-cured fiber-reinforced composite.
